(19) United States
(12) Patent Application Publication
(10) Pub. No.: US 2008/0116193 A1
(43) Pub. Date: May 22, 2008

(54) Portable multi-purpose electric oven

(76) Inventor: Hoi Tak Raymond Lam, Kowloon (CN)

Correspondence Address: ALIX YALE & RISTAS LLP, 750 MAIN STREET, SUITE 1400, HARTFORD, CT, 06103, US

(21) Appl. No.: 11/983,992

(22) Filed: Nov. 13, 2007

(30) Foreign Application Priority Data
Nov. 17, 2006 (CN) 200620157985.X

(51) Int. Cl. H05B 3/68; A21B 1/22; H05B 1/00

(52) U.S. Cl. 219/450.1; 219/393; 219/482

(57) ABSTRACT

A portable multi-purpose electric oven comprises: case-shaped upper and lower covers which can be opened and closed and have a handle; a pair of insert roasting plates with a built in heating device, wherein the plate has on one surface a plurality of protruding bars to form grids for roasting and the other surface of the plate is a plane for frying, and the transformation between the functions of frying and baking can be achieved if the plate is inserted reversely again after being pulled out; a pair of electrical outlets inside the upper and lower covers which can automatically spring up and are connected with the heating device inside the pair of the roasting plates; a pair of oil collecting cups for collecting oil flowing out from channels between the protruding bars on the pair of roasting plates; a heating plate which can be inserted over the roasting plates; and a set of electronic controlling devices comprising a plurality of buttons and indicator lights. The present oven can be used for both roasting and frying, the oil flowing out during roasting can be recycled, and the heat from roasting or frying can be used for unfreezing or heating.

### TECHNICAL FIELD

The present application relates to a kitchen utensil, and especially, to a portable multi-purpose electric oven.

### BACKGROUND ART

The oven has been known to all early. Even the electric oven has a development of decades, which results in that almost all the recent patent applications on an electric oven are focused on electric and electronic controlling, for example, [1] US Publication No. 2006/0191895; [2] US Publication No. 2005/0205544; and [3] CN 02152085.4. Even the prior art [1] and [2] listed above, although they are made portable in appearance, have a single function. For example, only solid foods such as pork, beef and fish can be roasted when the metal grid is used, while it can not cook fluidic foods such as eggs.

Any portable appliance should be designed to be used in environments on occasions such as a boat or ship and vehicles (train or travel car). Appliances used on such occasions require not only compactness and efficiency, but also, the most important thing is that the appliance should be multi-purpose. Many prior art devices cannot achieve the latter. For example, if a metal grid of the prior art is used, frozen cheese (or butter) which is just taken from a refrigerator, cannot be coated on fish when fish is roasted, let alone processing eggs. Conventional devices do not take into account the multi-purpose problem, while travelers will surely face this problem when traveling. The requirement of efficiency for traveling appliances does not only refer to the energy sources (such as saving electricity), but more importantly, it refers to saving the processed food. For example, for most ovens, the oils leaking from the roasted food flow away as waste, and other fresh oils are used in case of frying and coating. Thus, many things, that are not necessary, should be taken before travel, and also, it will result in much pollution on the way, thus threatening the environment during traveling.

Moreover, the requirement of multi-purpose for the portable appliances (including the electric oven) is endless, and the multi-purpose requirement for the electric oven in the prior art has not been satisfactorily resolved.

### SUMMARY

A purpose of the present oven lies in providing a portable multi-purpose electric oven, which can be used not only for roasting the solid foods such as meat and fish and frying fluidic foods such as eggs and cakes, but also for heating or melting the fatty foods such as cream and butter. The oven also preferably has an apparatus for collecting the oils flowing out from the foods during roasting for coating foods when they are fried.

The portable multi-purpose electric oven, according to one embodiment, mainly comprises: case-shaped upper and lower covers which can be opened and closed and have a handle; a pair of insert roasting plates with built in heating devices, wherein the plate has on one surface a plurality of protruding bars to form grids for roasting and the other surface of the plate is a plane for frying, and the transformation between the functions of frying and baking can be achieved if the plate is inserted reversely again after being pulled out; a pair of electrical outlets inside the upper and lower covers which can automatically spring up and are connected with the heating devices inside the pair of the roasting plates; a pair of oil collecting cups for collecting oil flowing out from channels between the protruding bars on the pair of roasting plates; a heating plate which can be inserted over the roasting plates; and a set of electronic controlling devices comprising a plurality of buttons and indicator lights.

In general, the portable multi-purpose electric oven for one embodiment can achieve the transformation between the functions of frying and baking, the oils flowing out from the roasting foods can be recycled, and the heat from roasting or frying can be used for unfreezing or heating.

### BRIEF DESCRIPTION OF THE DRAWINGS

FIG. 1 is a front perspective view of a portable multi-purpose electric oven, wherein the upper cover is opened by 30°.

FIG. 2 is a front perspective view of the portable multi-purpose electric oven, wherein the upper cover is opened by 90°.

FIG. 3 is a front perspective view of the portable multi-purpose electric oven, wherein the upper cover is opened by 180°.

FIGS. 4A and B are perspective views of the portable multi-purpose electric oven illustrating removal of roasting plates when the upper cover is opened by 180°.

FIG. 5 is a front perspective view of the portable multi-purpose electric oven, wherein the upper cover is closed.

FIG. 6 is a left view of the portable multi-purpose electric oven.

FIG. 7 is a back view of the portable multi-purpose electric oven.

FIG. 8 is a bottom view of the portable multi-purpose electric oven.

### DETAILED DESCRIPTION OF THE PREFERRED EMBODIMENTS

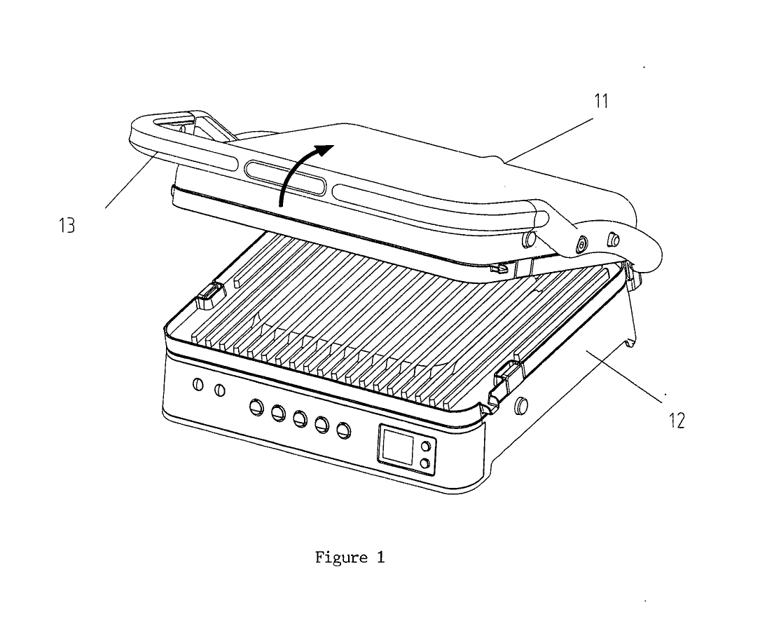

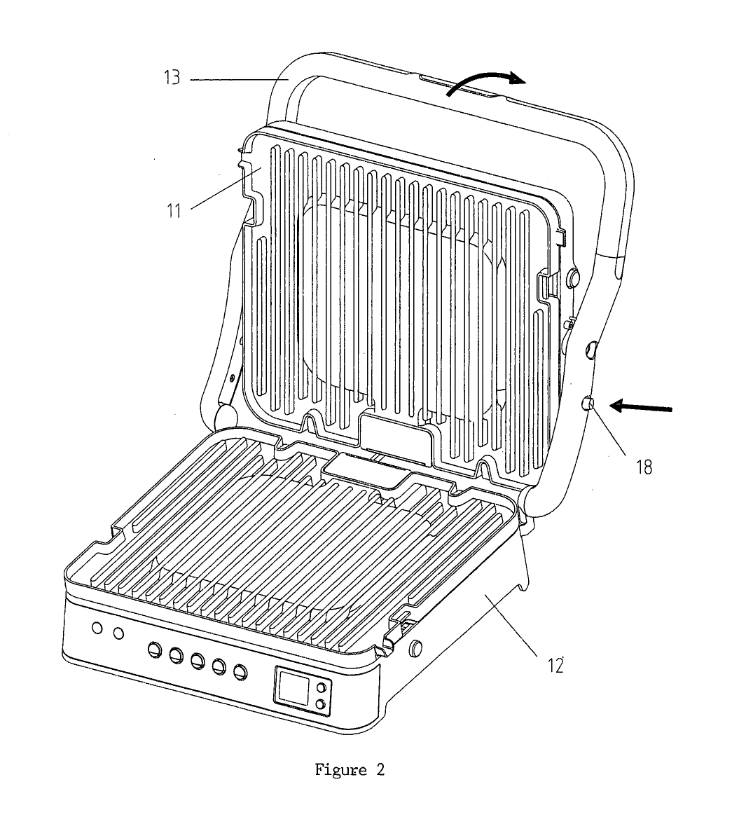

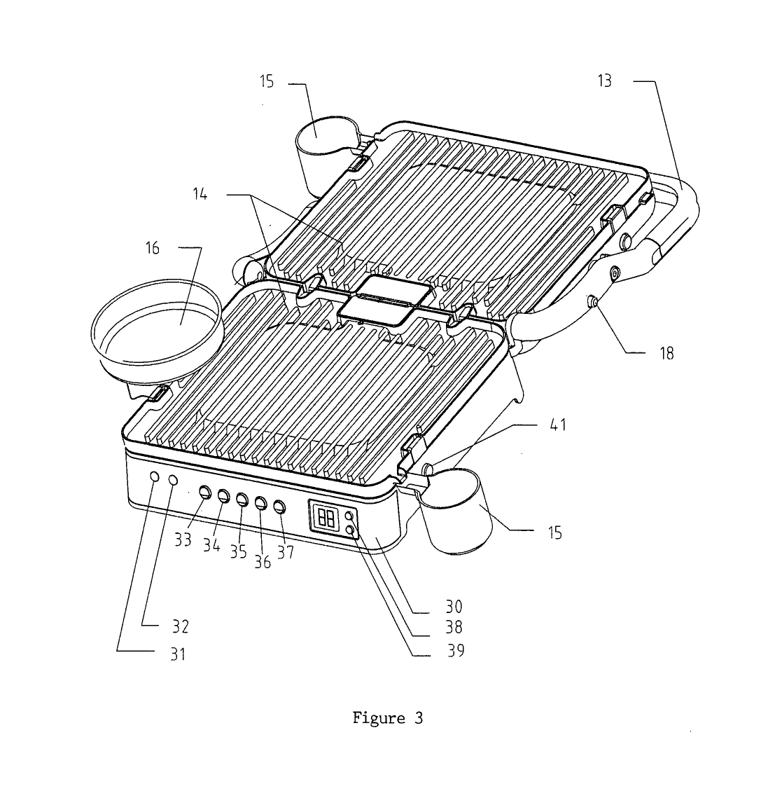

The portable multi-purpose electric oven will now be explained with reference to the drawings. It can be seen from the perspective views of FIGS. 1 to 5 that the portable multi-purpose electric oven has the same general appearance with that of the prior art for many features. It has a pair of case-shaped covers, i.e., upper cover 11 and lower cover 12, which can be opened and closed, and a handle 13. FIG. 1 is a front perspective view of the portable multi-purpose electric oven according to the present utility model when the upper cover 11 is opened by 30°. FIGS. 2 and 3 are the perspective views when the upper cover 11 in FIG. 1 is opened respectively by 90° and 180°. At the position as shown in FIG. 2, if the button 18 on the handle 13 is pressed, the upper cover 11 can be laid flat as the position shown in FIG. 3.

In each perspective view, only the surface with protruding bars (i.e., grids) 21 on the roasting plates 14 is shown. The other surface of the roasting plates 14 is a plane, which is not drawn in any of the figures. The heating device inside the roasting plates 14 belongs to the prior art, which will not be further described. If the roasting plates 14 are inserted reversely, it can be used for frying foods (such as frying eggs and baking cakes). In FIG. 3, when the upper cover 11 and the lower cover 12 are fully opened and laid flat, two roasting plates 14 with protruding bars 21 can be seen. The position of the roasting plates 14 between the upper and lower cover 11 and 12 is the same with the prior art in appearance. In FIG. 3, there is a pair of oil collecting cups 15 for collecting the oil flowing out from channels between the protruding bars 21. The oil in cups 15 can be used for coating foods during roasting or frying, or for coating the plane surface of the roasting plates 14 which is used for frying, so as to prevent the food from being burnt during frying. Although the plane can be coated with a burn-prevention coating on the surface, it also aims to prevent the foods from being burned to coat oil on the surface of the pan when food is fried.

In FIG. 3, a heating plate 16 provided over the roasting plates 14 can be seen. It is used for unfreezing foods such as the frozen cream and cheese or for heating some foods by using the heat from roasting or frying. It can not be used for boiling foods. In fact, either the oil collecting cups 15 or the heating plate 16 is shown schematically, their appearances and sizes can be changed in practice, and the methods for fixing them are arbitrary, too. For example, they can be clamped onto some appropriate parts by clips, or they can be inserted into corresponding holes by pins.

In FIG. 3, a control panel 30 also can be seen. From the left to the right, the panel 30 includes: a power-on indicator light 31, a ready indicator light 32, a heating button 33, a low temperature button 34, an intermediate temperature button 35, a high temperature button 36, a roasting button 37, a temperature increase button 38, and a temperature decrease button 39. On the left of the temperature increase button and the temperature decrease button is a two-digital display screen. Because the inventive features of the portable multi-purpose electric oven do not lie in the operation and control of the heating assembly and the temperature, any suitable heating elements and controlling circuit in the prior art can be used in the portable multi-purpose electric oven.

FIG. 4 is a perspective view of the portable multi-purpose electric oven, wherein the roasting plates are taken out when the upper cover is opened by 180°. The perspective view on the upper part of FIG. 4 shows the circumstance that the roasting plate 14 in the lower cover 12 is pulled from the electrical outlet 17 of the lower cover 12. The purpose for pulling out the roasting plates 14 lies in inserting it reversely again, so that the plane for frying of the roasting plates 14 is upward, and then frying can be conducted. In order to pull out the roasting plates 14, the buttons 41 on the two sides of the lower cover 12 should be pressed. Therefore, the pair of hooks 43 which initially hook and fasten the roasting plates 14 are loosened, and then the roasting plates 14 can be pulled out upward by 30° as shown. Springs (not shown) are installed under the electrical outlet 17 so that the electrical outlet 17 is always pushed upward by 30°. Therefore, even when the roasting plates 14 are pulled out from the electrical outlet 17, the electrical outlet 17 still remains at a position of 30° upward so that the roasting plates 14 can be inserted back again.

The perspective view on the lower part of FIG. 4 shows the circumstance that the roasting plates 14 in the upper cover 11 are pulled out from the electrical outlet 17 of the upper cover 11. The method is the same with the description in the preceding paragraph. Once the buttons 42 on the two sides of the upper cover 11 are pressed, the pair of hooks 44 will be loosened, the roasting plates 14 in the upper cover 11 can be pulled upward by 30°, and then the roasting plates 14 can be pulled out from the electrical outlet 17 of the upper cover 11. Springs (not shown) always push up the electrical outlet 17 of the upper cover 11 by 30°, so that the roasting plates 14 can be inserted back again.

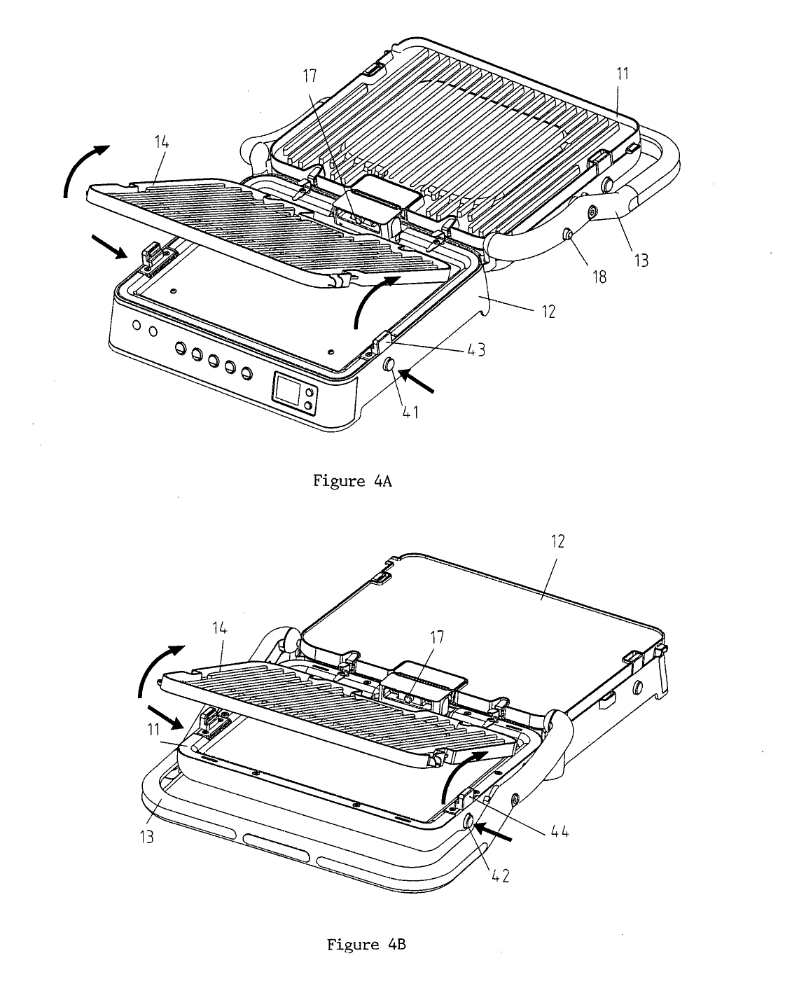

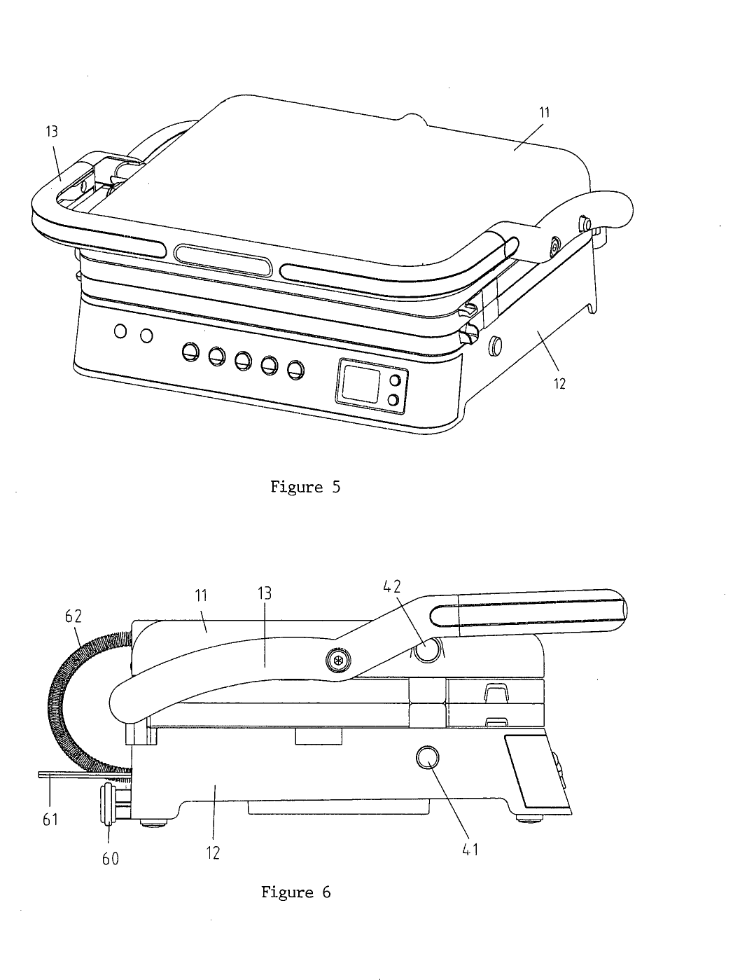

FIG. 5 shows the appearance of the portable multi-purpose electric oven when it is not used and fully closed.

FIG. 6 is a left view of the portable multi-purpose electric oven. All the perspective views have already shown the top, front and the right side of the portable multi-purpose electrical oven, so herein one view is used for showing the left side. In fact, the left side and the right side are symmetrical. In FIG. 6, the buttons 41 and 42 on the left side of the upper and lower covers 11 and 12 can be seen as mentioned above, and a protruding pole 60, which can also be seen, is used for keeping the body of the oven away from the wall in order to prevent fire. Because the protruding pole 60 is on the back surface of the oven, a lead-in line 61 of the power and the electrical wire 62, protected by a spring, from the lower cover 12 to the upper cover 11 are on this surface, and both the two wires are not fit to be clamped between the back surface of the oven and the wall.

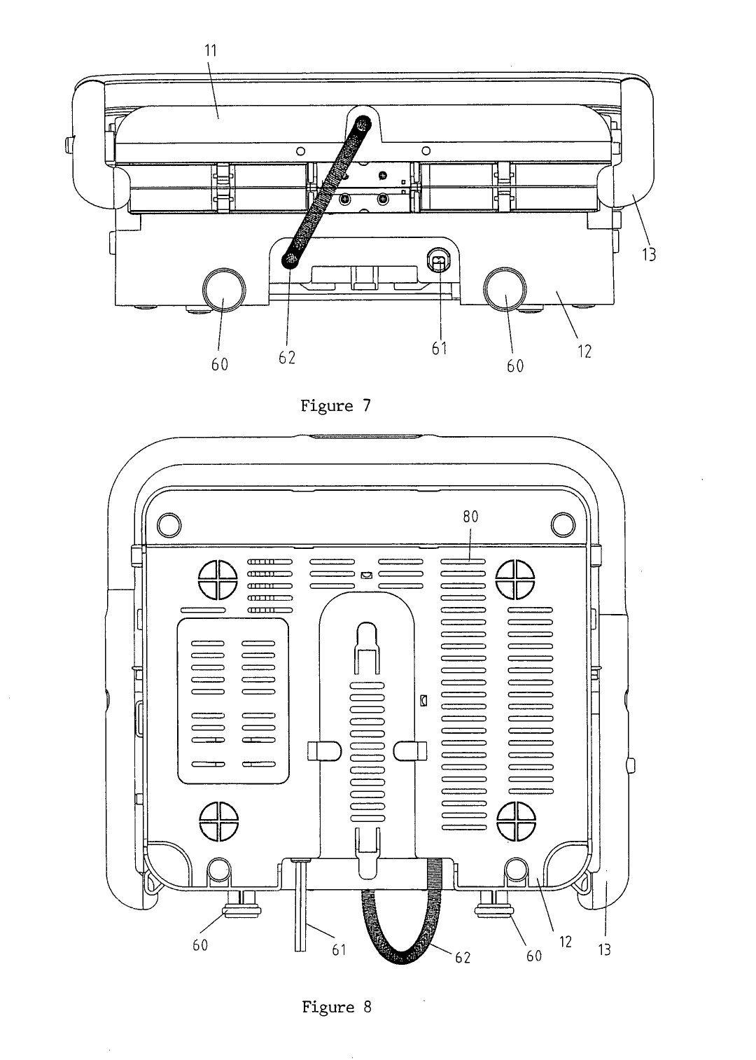

FIG. 7 is a back view of the portable multi-purpose electric oven. It can be seen from this figure that there are two protruding poles 60, and the positions of the lead-in line of the power and the connection line 62 between the upper and lower covers 11 and 12 can also be seen. Of course, these positions are only schematic. Some changes of these positions will not affect the invention point of the portable multi-purpose electric oven.

FIG. 8 is a bottom view of the portable multi-purpose electric oven, and it is also schematic. The size and position of each vent 80 can be changed appropriately.

While the present invention has been particularly shown and described with reference to exemplary embodiments thereof, it will be understood by those of ordinary skill in the art that various changes in form and details may be made therein without departing from the spirit and scope of the present utility model as defined by the following claims. Therefore, it is to be understood that the above-described embodiments have been provided only in a descriptive sense and will not be construed as placing any limitation on the scope of the invention.

What is claimed is:

1. A portable multi-purpose electric oven comprising:
case-shaped upper and lower covers which can be opened and closed and have a handle;
a pair of roasting plates with built in heating devices;
a set of electronic controlling devices comprising a plurality of buttons and indicator lights;
being characterized in:
the roasting plates having on one surface a plurality of protruding bars to form grids for roasting and the other surface being a plane for frying, and the transformation between the functions of frying and baking can be achieved if the pair of plates are inserted reversely again after being pulled out;
a pair of electrical outlets inside the upper and lower covers which can automatically spring up and are connected with the heating device inside the pair of the roasting plates;
a pair of oil collecting cups for collecting oil flowing out from channels between the protruding bars on the pair of roasting plates; and
a heating plate which can be inserted over the roasting plates.

2. The electric oven according to claim 1, characterized in that after the pair of roasting plates is inserted into the electrical outlets, the pair of roasting plates are hooked and fixed by a pair of hooks when the roasting plates are pulled into their respective upper and lower covers.
